(19) United States
(12) Patent Application Publication
(10) Pub. No.: US 2026/0366919 A1
(43) Pub. Date: Nov. 19, 2026

(54) STANDOFF ACCESSORY FOR HANDHELD AND PORTABLE RAMAN SPECTROSCOPY DEVICES

(71) Applicant: Rigaku Analytical Devices, A Division of Rigaku Americas Holding, Inc., Wilmington, MA (US)

(72) Inventors: Christian Hoffman, Bolton, MA (US); Luisa T.M. Profeta, Fremont, NH (US); Michael D. Hargreaves, Burlington, MA (US)

(21) Appl. No.: 19/430,427

(22) Filed: Dec. 23, 2025

Related U.S. Application Data
(60) Provisional application No. 63/808,117, filed on May 19, 2025.

(51) Int. Cl. G01J 3/02; G01J 3/06; G01J 3/28; G01J 3/44

(52) U.S. Cl. CPC G01J 3/0291; G01J 3/0208; G01J 3/0237; G01J 3/0272; G01J 3/06; G01J 3/2823; G01J 3/4412; G01J 2003/064

(57) ABSTRACT

A standoff accessory configured to operatively interface with a handheld or otherwise portable Raman spectroscopy device is disclosed. The disclosed accessory may be configured, at least in part, to couple with a given compatible Raman spectroscopy device in a manner which augments one or more scanning capabilities native to that device. For instance, the disclosed standoff accessory may include an optical assembly and/or an electronics assembly which enable a coupled Raman spectroscopy device to scan targeted material(s)-both on surfaces and within optically translucent/transparent containers-accurately at an extended standoff distance in the range of about 1-5 m. In an example embodiment, the disclosed accessory may be configured for use with a portable, semiconductor-based Raman spectroscopy device that operates at a wavelength of 1,064 nm.

### CROSS-REFERENCE TO RELATED APPLICATIONS

This patent application claims the benefit of U.S. Provisional Patent Application No. 63/808,117, titled “Standoff Accessory for Handheld and Portable Raman Spectroscopy Devices,” filed on May 19, 2025, which is herein incorporated by reference in its entirety.

### FIELD OF THE DISCLOSURE

The present disclosure relates to Raman spectroscopy devices and, more particularly, to accessories for handheld and portable Raman spectroscopy devices.

### BACKGROUND

Raman spectroscopy is an established vibrational technique that produces a spectrum that relates to features in the molecular structure of a targeted sample. The Raman spectrum of each compound is unique and serves as a chemical fingerprint which can be used to identify compound(s) present in the targeted sample.

### SUMMARY

The subject matter of this application may involve, in some cases, interrelated products, alternative solutions to a particular problem, and/or a plurality of different uses of a single system or article.

A first example embodiment provides a standoff accessory configured to operatively interface with a handheld or otherwise portable Raman spectroscopy device, the standoff accessory including: a first body portion configured to physically host the Raman spectroscopy device; a second body portion including: an optics assembly including a first optic; and an actuator configured to move the first optic along an optical axis of the optics assembly; and an interface portion configured to optically couple the Raman spectroscopy device with the optics assembly such that movement of the first optic along the optical axis augments a Raman scanning capability native to the Raman spectroscopy device, allowing for scanning of a targeted sample by the Raman spectroscopy device at a standoff distance of about 1-5 m away from the targeted sample.

In some cases, the optics assembly is configured as a scope. In some cases, the first optic includes a negative lens. In some cases, the optics assembly further includes a second optic which is fixed in position along the optical axis of the optical assembly. In some cases, the second optic includes at least one focusing lens. In some cases, the at least one focusing lens includes: a first focusing lens which is configured as a plano-convex lens; and a second focusing lens which is configured as a double-convex lens. In some cases, the second optic further includes an optical window.

In some cases, the standoff accessory further includes an electronics assembly configured to cause the actuator to move the first optic along the optical axis of the optics assembly. In some cases, the electronics assembly further includes a power supply electrically coupled with the actuator. In some cases, the power supply includes a battery.

In some cases, the standoff accessory further includes an aiming device configured to emit visible light. In some cases, the visible light includes a wavelength in the range of about 380–700 nm. In some cases, the visible light includes a wavelength in the range of about 495–570 nm. In some cases, the aiming device is boresighted with the optical axis of the optical assembly.

In some cases, the optics assembly further includes a beamsplitter configured to combine the visible light emitted by the aiming device with an output of the Raman spectroscopy device. In some cases, the beamsplitter includes a dichroic mirror. In some cases, the first optic is movable relative to the beamsplitter.

In some cases, the standoff accessory further includes a rangefinder device configured to determine the standoff distance. In some cases, the rangefinder device is configured for time-of-flight (TOF) or light detection and ranging (LIDAR)-based range-finding. In some cases, the actuator is configured to move the first optic along the optical axis of the optics assembly based, at least in part, on data received from the rangefinder device.

In some cases, the standoff accessory further includes an image capture device configured to capture at least one of a still image and a video of the targeted sample.

In some cases, the platform is a firearm. In some cases, the platform is an unmanned ground vehicle (UGV) or an unmanned aerial vehicle (UAV). In some cases, the platform is a stationary, fixed platform.

A second example embodiment provides an assembly including: the standoff accessory of the first example embodiment; and the Raman spectroscopy device.

In some cases, the Raman spectroscopy device includes an excitation laser configured to emit near-infrared (NIR) light. In some cases, the NIR light includes a wavelength in the range of about 1,000–1,500 nm. In some cases, the NIR light includes a wavelength of 1,064 nm.

In some cases, the Raman spectroscopy device is a semiconductor-based Raman spectroscopy device configured to operate at a wavelength of 1,064 nm. In some cases, the Raman spectroscopy device includes a detector that is sensitive to near-infrared (NIR) light. In some cases, the detector includes at least one of: an indium-gallium-arsenide (InGaAs) sensor; a charge-coupled device (CCD)-style sensor; an intensified CCD (ICCD)-style sensor; and a complimentary metal–oxide–semiconductor (CMOS)-style sensor.

The features and advantages described herein are not all-inclusive and, in particular, many additional features and advantages will be apparent to one of ordinary skill in the art in view of the drawings, specification, and claims. Moreover, it should be noted that the language used in the specification has been selected principally for readability and instructional purposes and not to limit the scope of the inventive subject matter.

### BRIEF DESCRIPTION OF THE DRAWINGS

FIG. 1 illustrates a first isometric view of a standoff accessory configured in accordance with an embodiment of the present disclosure.

FIG. 2 illustrates a second isometric view of the standoff accessory of FIG. 1.

FIG. 3 illustrates a side elevation view of the standoff accessory of FIG. 1.

FIG. 4 illustrates a top-down plan view of the standoff accessory of FIG. 1.

FIG. 5 illustrates an end view of the standoff accessory of FIG. 1.

FIG. 6 illustrates a first isometric view of an assembly including a Raman spectroscopy device operatively coupled with a standoff accessory configured in accordance with an embodiment of the present disclosure.

FIG. 7 illustrates a second isometric view of the assembly of FIG. 6.

FIG. 8 illustrates a side elevation view of the assembly of FIG. 6.

FIG. 9 illustrates a top-down plan view of the assembly of FIG. 6.

FIG. 10 illustrates a cross-sectional view of an optics assembly of a standoff accessory configured in accordance with an embodiment of the present disclosure.

FIG. 11 is a block diagram illustrating an assembly of a Raman spectroscopy device operatively coupled with a standoff accessory configured in accordance with an embodiment of the present disclosure.

FIG. 12 is a plot of several Raman spectra relating to a Calcium Ammonium Nitrate sample disposed on tile, as detected at distances of 1 m, 2 m, and 3 m utilizing a standoff accessory configured in accordance with an embodiment of the present disclosure.

FIG. 13 is a plot of several Raman spectra relating to a Potassium Chlorate sample disposed on tile, as detected at distances of 1 m, 2 m, and 3 m utilizing a standoff accessory configured in accordance with an embodiment of the present disclosure.

FIG. 14 is a plot of several Raman spectra relating to a Benzonitrile sample disposed within a brown bottle, as detected at distances of 1 m, 2 m, and 3 m utilizing a standoff accessory configured in accordance with an embodiment of the present disclosure.

FIG. 15 is a plot of several Raman spectra relating to an Acetaminophen sample disposed within a brown bottle, as detected at distances of 1 m, 2 m, and 3 m utilizing a standoff accessory configured in accordance with an embodiment of the present disclosure.

FIG. 16 is a plot of several Raman spectra relating to a Xylazine Hydrochloride sample disposed within a clear glass bottle, as detected at distances of 1 m, 2 m, and 3 m utilizing a standoff accessory configured in accordance with an embodiment of the present disclosure.

FIG. 17 is a plot of several Raman spectra relating to (a) a Calcium Ammonium Nitrate sample disposed on tile, (b) an Acetaminophen sample disposed within a clear, low-density polyethylene (LDPE) bag, and (c) a Potassium Perchlorate sample disposed on tile, as detected at distances ranging between 1.5–2.0 m in an indoor environment utilizing a standoff accessory configured in accordance with an embodiment of the present disclosure.

FIG. 18 is a plot of several Raman spectra relating to (a) a Dinitrotoluene sample disposed within a clear, glass vial, (b) a Hexamine sample in tablet form disposed within an LDPE bag, and (c) a Urea sample in pill form disposed within an LDPE bag, as detected at distances ranging between 1.5–2.0 m in an outdoor, sunny environment utilizing a standoff accessory configured in accordance with an embodiment of the present disclosure.

These and other features of the present embodiments will be understood better by reading the following detailed description, taken together with the figures herein described. The accompanying drawings are not intended to be drawn to scale. In the drawings, each identical or nearly identical component that is illustrated in various figures may be represented by a like numeral. For purposes of clarity, not every component may be labeled in every drawing.

### DETAILED DESCRIPTION

A standoff accessory configured to operatively interface with a handheld or otherwise portable Raman spectroscopy device is disclosed. The disclosed accessory may be configured, at least in part, to couple with a given compatible Raman spectroscopy device in a manner which augments one or more scanning capabilities native to that device. For instance, the disclosed standoff accessory may include an optical assembly and/or an electronics assembly which enable a coupled Raman spectroscopy device to scan targeted material(s)—both on surfaces and within optically translucent/transparent containers—accurately at an extended standoff distance in the range of about 1–5 m. In an example embodiment, the disclosed accessory may be configured for use with a portable, semiconductor-based Raman spectroscopy device that operates at a wavelength of 1,064 nm. Numerous configurations and variations will be apparent in light of this disclosure.

### General Overview

Handheld and portable Raman spectroscopy permits a user to bring analytical abilities typically found in the laboratory to non-laboratory sites. Utilizing advances in optics and electronics miniaturization, handheld and portable Raman instrumentation can allow users to investigate unknown materials of either pure chemical or mixture composition. A limitation of handheld or portable Raman instruments is that proximity (e.g., at a distance of less than 3 cm) is typically required for material identification. Such proximity to an unknown sample is not a problem for many users of handheld Raman, but for certain applications, such as explosives detection, proximity is undesirable. Users also dealing with other potentially harmful materials, such as chemical warfare agents (CWAs), narcotics, and toxic industrial chemicals/materials (TICs/TIMs), also find difficulty with proximity for analysis.

Several approaches to analyzing hazardous materials without close contact using optical spectroscopy methods have been explored in prior art. As a first example, passive infrared (IR) spectroscopy has been employed for standoff detection of gaseous materials and is preferred for aerosolized chemical threats. Passive IR, however, is less suitable for solid and liquid identification of unknown compounds due to the overwhelming inference of atmospheric water vapor, making it especially less suitable for detection of explosives or non-volatile materials.

As a second example, standoff Raman spectroscopy allows for increased sample analysis versatility versus passive IR, being amenable to sampling gas, liquid, and solid phase materials. Some prior approaches for standoff Raman spectroscopy utilize a visible excitation laser. Other variants use excitation lasers that are in the ultraviolet (UV) range or in the near-infrared (NIR) range. A number of these prior standoff Raman systems combine Raman and laser-induced breakdown spectroscopy (LIBS) technology or another laser-based analytical method. Unifying these prior efforts is that the laser power delivered to an unknown material is sufficiently high for measurement purposes but maintained at a comparatively low power density (except in the case of LIBS), thereby preventing detonation or deflagration of all but the most sensitive explosives.

One downside to these prior efforts in standoff Raman spectroscopy for hazardous material detection is equipment size. Existing standoff Raman setups (a) are quite large, requiring large cart or vehicular transport for field applications, (b) are not sufficiently ruggedized to withstand regular field use, (c) are not convertible to a close-proximity analysis configuration if so desired, and (d) require an expert user to operate and discern instrumentation outputs. Users of these existing standoff Raman setups understand the compromises of size, ruggedness, and adaptability to proximity. Oftentimes, the solution for both close-proximity analysis and standoff-analysis is the use of two individual pieces of equipment to respectively analyze as noted, which adds time and financial costs to any operational scenario.

In view of these and other notable deficiencies of the existing approaches, there remains a demand for standoff Raman spectroscopy to be small, rugged, and convertible between standoff and handheld use for expedient and optimized detection of unknown hazardous material(s). Moreover, it is envisioned that many users of such technology for hazardous material identification likely would not be scientific experts in Raman spectroscopy. As such, standoff Raman instrumentation that can provide a more simplified user interface (UI) with easy-to-discern outputs would be desirable.

Thus, and in accordance with some embodiments of the present disclosure, a standoff accessory configured to operatively interface with a handheld or otherwise portable Raman spectroscopy device is disclosed. The disclosed accessory may be configured, at least in part, to couple with a given compatible Raman spectroscopy device in a manner which augments one or more scanning capabilities native to that device. For instance, the disclosed standoff accessory may include an optical assembly and/or an electronics assembly which enable a coupled Raman spectroscopy device to scan targeted material(s)—both on surfaces and within optically translucent/transparent containers—accurately at an extended standoff distance in the range of about 1–5 m. In an example embodiment, the disclosed accessory may be configured for use with a portable, semiconductor-based Raman spectroscopy device that operates at a wavelength of 1,064 nm.

As discussed herein, the disclosed standoff accessory optionally may include any of a range of electronic and/or mechanical features which facilitate operation of a Raman spectroscopy device at distance. For example, in some embodiments, the disclosed standoff accessory may include a laser pointer configured to emit visible light, thereby facilitating accurate aiming of the Raman spectroscopy device at a sample targeted by the user. In some embodiments, the disclosed standoff accessory may include a rangefinder (e.g., configured for time-of-flight (TOF) or light detection and ranging (LIDAR)-based range-finding), thereby facilitating accurate sample distancing and adjustment of the optics assembly of the accessory by the user. In some embodiments, the disclosed standoff accessory may include an image capture device (e.g., a still camera or video camera) configured for providing feedback (e.g., live, periodic, or real-time) to (a) the user and/or (b) one or more control elements (e.g., command-and-control software). In some embodiments, the disclosed standoff accessory may include (or otherwise be configured to host) an on-board power supply (e.g., a battery), which optionally may be integrated in part or in whole with an electronics assembly of the standoff accessory. In some embodiments, the disclosed standoff accessory may include a mounting portion configured for mounting the accessory to a given platform, mobile or otherwise.

As will be appreciated in light of this disclosure, the disclosed standoff accessory may be compatible for use with any of a wide range of handheld or otherwise portable Raman spectroscopy devices typically used for identifying any of a wide range of chemical species in solid, semi-solid, and liquid samples alike. For example, in accordance with some embodiments, the disclosed standoff accessory may be particularly well-suited for use with an Icon-X handheld Raman spectroscopy device commercially available from Rigaku Holdings Corporation and its subsidiaries. As such, the disclosed standoff accessory may be utilized, in accordance with some embodiments, in detecting any one (or combination) of the following: explosives; explosive precursors; chemical warfare agents (CWAs); CWA precursors; narcotics; narcotics precursors; toxic industrial chemicals (TICs); toxic industrial materials (TIMs); and any other chemicals that generate a Raman spectrum. More generally, the disclosed standoff accessory may be configured for use with a given compatible Raman spectroscopy device in collecting chemical Raman scattering profiles and analyzing them from a safe standoff distance.

As will be further appreciated in light of this disclosure, the disclosed standoff accessory and related techniques may realize one or more advantages or benefits as compared to existing approaches. For example, some embodiments need not rely on fluorescence reduction and removal techniques. Some embodiments need not rely on a motorized incident laser beam for sampling. Some embodiments are ruggedized for stable and consistent performance in field applications. Some embodiments do not require external, water-based cooling systems. Some embodiments do not require user-initiated calibration. Some embodiments do not require detector systems that are not ingress protection (IP)-rated. Some embodiments do not require shading or blocking of solar radiation to determine a material identity. Some embodiments are portable and readily mounted to various stationary or variable/mutable support platforms. Some embodiments have ease of communication with the user and intuitive responsivity to operation of the system. Some embodiments provide for operation of the optical detector system to be performed on-board the core Raman spectroscopy device or remotely (e.g., through another user interface). Some embodiments provide for streamlined mechanical switching between point-and-shoot operation (e.g., at distances of 1 m or less) and proximal standoff operation (e.g., at distances between about 1–5 m).

Also, it should be noted at the outset that, although particular types of hardware (e.g., optics, lasers, spectrometers, and detectors) are described herein, the present disclosure is not intended to be so limited, as additional and/or different components may be used, in light of the teachings of this disclosure, to produce a streamlined standoff accessory and system that are switchable between point-and-shoot and standoff Raman operational modes.

### Structure and Operation

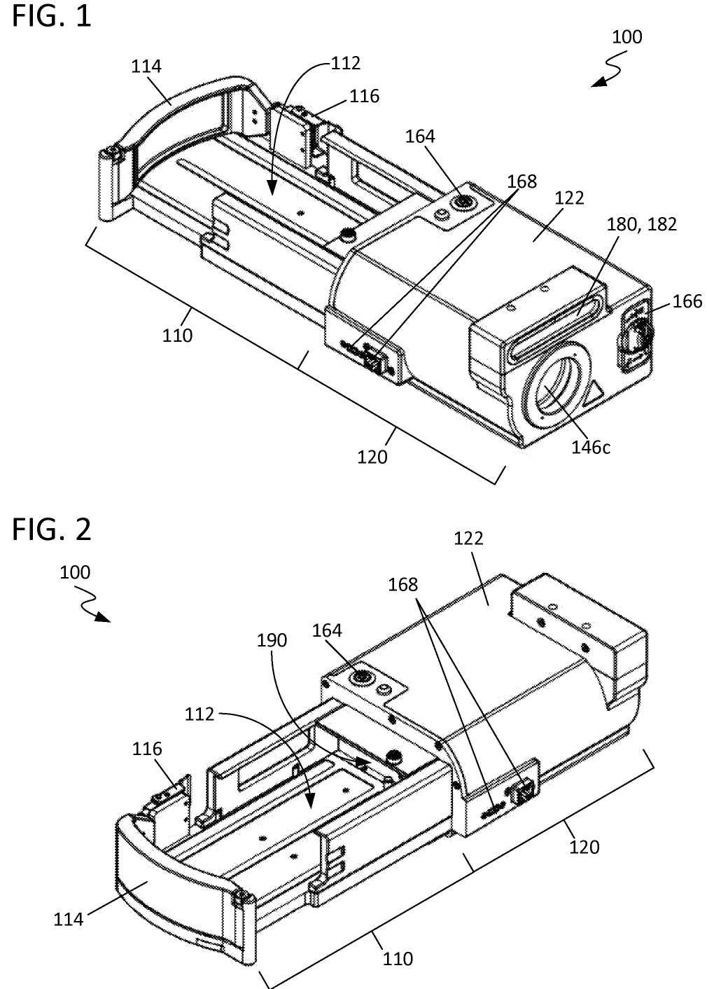

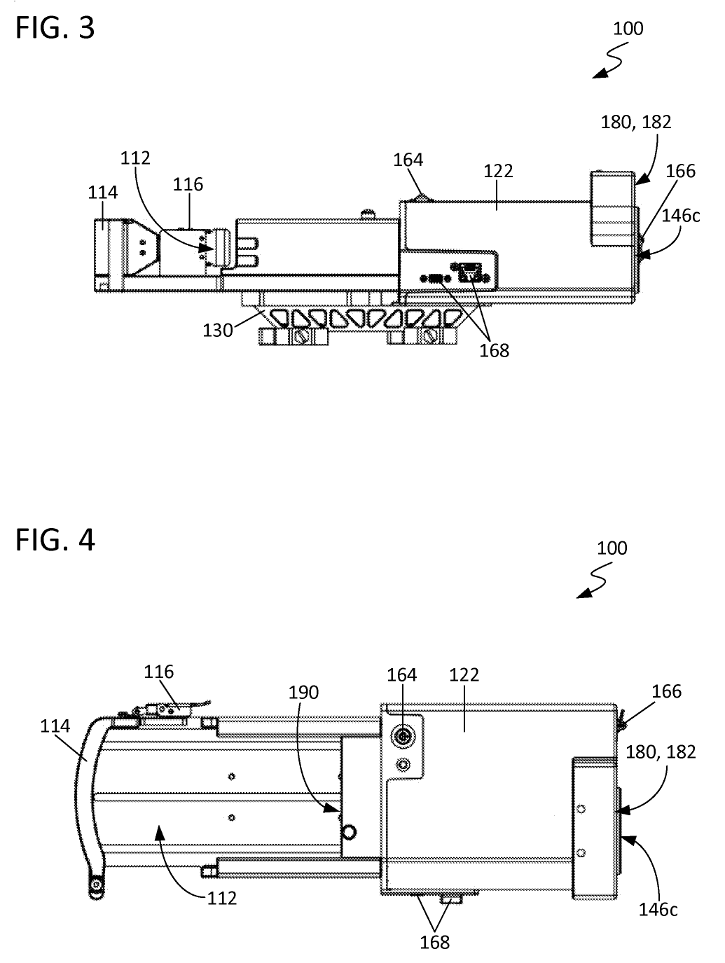

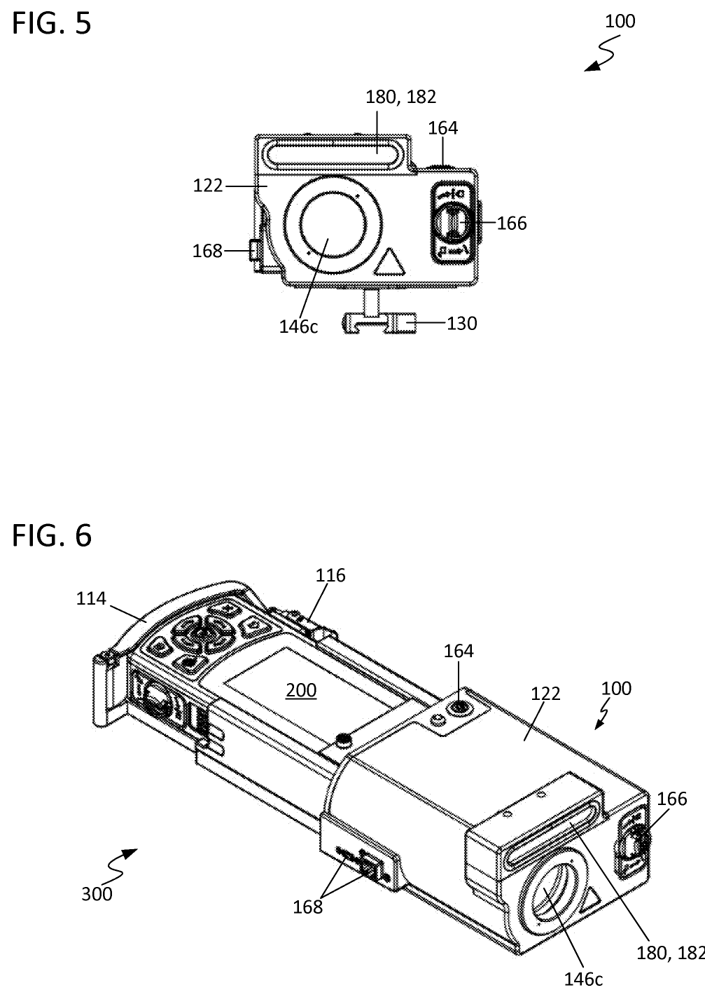

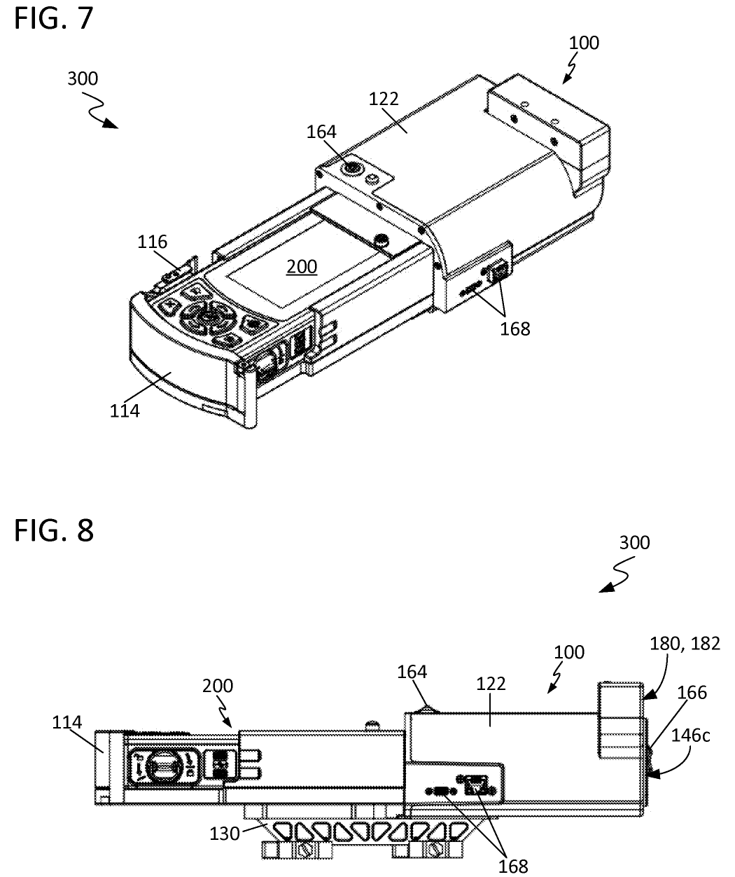

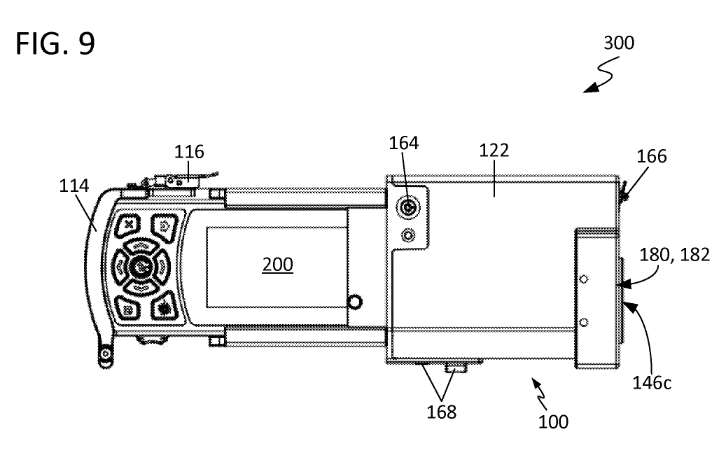

FIGS. 1–5 illustrate several views of a standoff accessory 100 configured in accordance with an embodiment of the present disclosure. As discussed herein, accessory 100 may be configured, at least in part, to optically, electrically, and/or mechanically couple with a handheld or otherwise portable Raman spectroscopy device 200. For instance, consider FIGS. 6–9, which illustrate several views of an example assembly 300 including a device 200 operatively coupled with an accessory 100 configured in accordance with an embodiment of the present disclosure. As further discussed herein, in physically hosting a device 200, accessory 100 may be configured, at least in part, to operatively interface that device 200 with (a) an optics assembly 140 and/or (b) an electronics assembly 160 so as to augment one or more Raman spectroscopy scanning capabilities native to that device 200. More specifically, operative interfacing of accessory 100 and device 200 may serve, at least in part, to increase the effective distance at which device 200 may scan a targeted sample accurately.

As can be seen from FIGS. 1–9, accessory 100 may include a first body portion 110 (e.g., a rearward portion). First body portion 110 may be configured, at least in part, to physically host device 200 on a temporary or permanent basis. More specifically, accessory 100 may be configured such that device 200 is repeatably (dis)mountable with respect thereto. To such ends, first body portion 110 may include a receiving space 112 configured to receive (e.g., cradle or otherwise house) device 200, in part or in whole. In some embodiments, first body portion 110 may be configured such that device 200 is insertable therein in a sliding manner (e.g., from an end or side of accessory 100). It should be noted, however, that other suitable options for reception and retention (e.g., snap-fitting, bracketing, clamping, etc.) of device 200 by first body portion 110 will be apparent in light of this disclosure. As will be appreciated, the dimensions and geometry of compatible devices 200 may vary, and so the dimensions and geometry of receiving space 112 (and of first body portion 110 more generally) may be customized accordingly, as desired for a given target application or end-use.

In accordance with some embodiments, first body portion 110 optionally may include one or more means for securing device 200 within receiving space 112. For example, as can be seen from FIGS. 1–9, first body portion 110 may include a securing bracket 114 configured to abut device 200 (e.g., at an end or side thereof), thereby tending to hold device 200 in place within receiving space 112. As can be seen further from FIGS. 1–9, first body portion 110 also may include a locking mechanism 116 configured to lock (e.g., bias or otherwise hold) securing bracket 114 in a position which maintains such abutment between securing bracket 114 and device 200. It should be noted, however, that securing bracket 114 and locking mechanism 116 are not intended to be limited only to the example configuration shown in FIGS. 1–9, as other suitable configuration(s) will be apparent in light of this disclosure.

As can be seen further from FIGS. 1–9, accessory 100 also may include a second body portion 120 (e.g., a forward portion). Second body portion 120 may be configured, at least in part, as a housing 122 configured to house (a) an optics assembly 140, (b) an actuator 150, and (c) an electronics assembly 160, each discussed in further detail below. As will be appreciated, the dimensions and geometry of second body portion 120 may be customized, as desired for a given target application or end-use.

As noted above, accessory 100 may include an optics assembly 140. Generally, optics assembly 140 may be configured to optically interface with an upstream device 200 and augment the Raman spectroscopy scanning capabilities native to that device 200. More specifically, optics assembly 140 may be configured, in accordance with some embodiments, to increase the effective distance at which device 200 may scan a targeted sample accurately (e.g., at least sufficiently accurate for proper detection of spectral signature(s) actually present). For example, in some cases, optics assembly 140 may enable device 200 (when assembled with accessory 100) to obtain accurate Raman measurements at a standoff distance in the range of about 1–5 m away from device 200 (e.g., about 1–2 m, about 2–3 m, about 3–4 m, about 4–5 m, or any other sub-range in the range of about 1–5 m). In some specific cases, optics assembly 140 may provide for an effective standoff distance of about 3 m or less (e.g., about 2.5 m or less, about 2.0 m or less, about 1.5 m or less, about 1.0 m or less, or any other sub-range in the range of about 3 m or less). In some cases, optics assembly 140 may provide for an effective standoff distance of about 2.0 m ± 1.0 m.

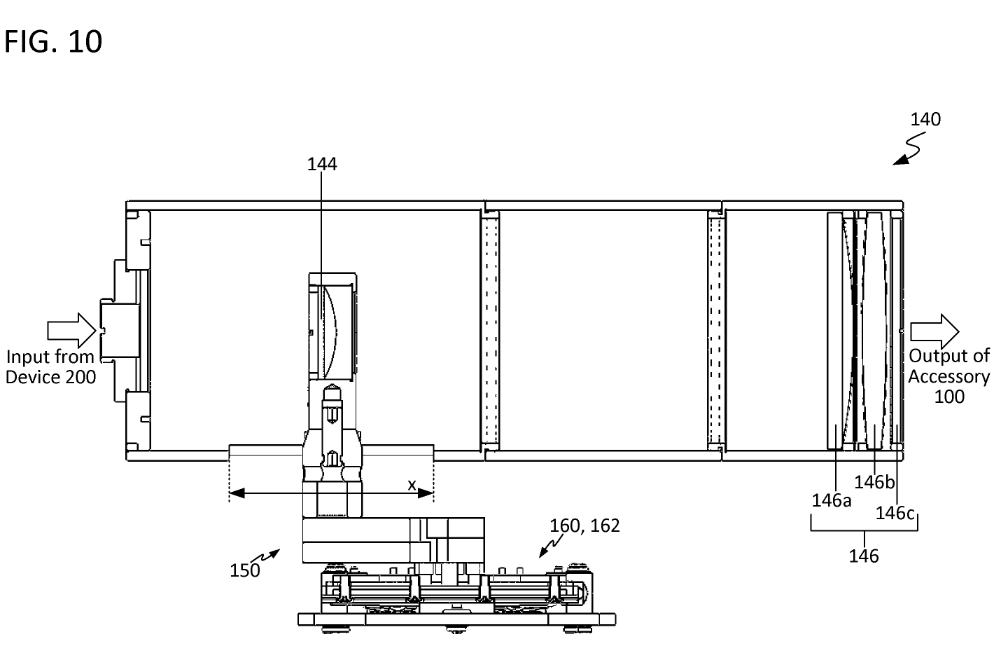

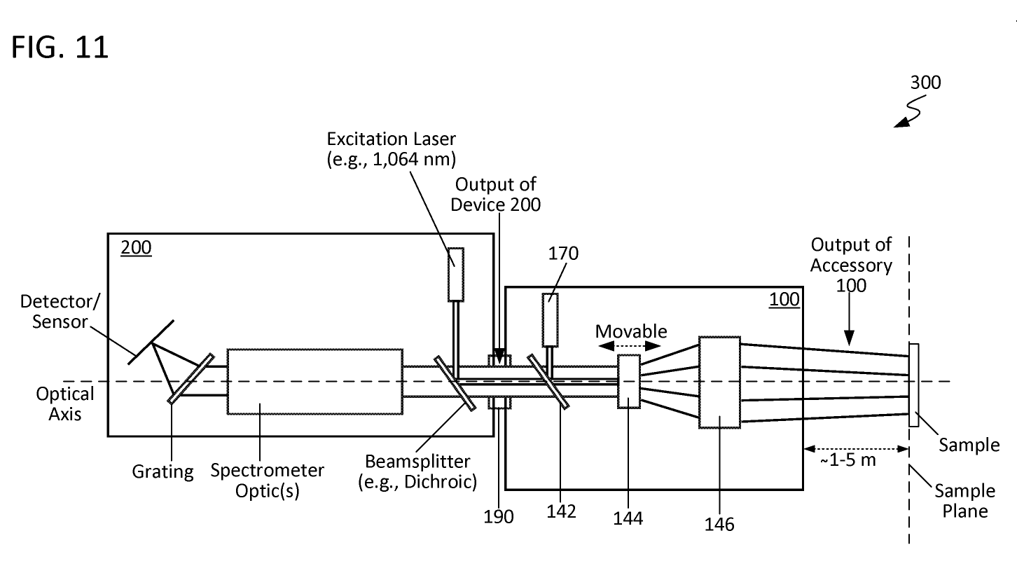

FIG. 10 illustrates a cross-sectional view of an optics assembly 140 configured in accordance with an embodiment of the present disclosure. FIG. 11 is a block diagram illustrating an assembly 300 of device 200 operatively coupled with accessory 100 in accordance with an embodiment of the present disclosure. As can be seen from FIGS. 10–11, optics assembly 140 generally may be configured as a scope including a plurality of optical components disposed within a housing 122, including, for example: (1) a beamsplitter 142; (2) a first optic (or optics group) 144; and (3) a second optic (or optics group) 146. Each of these elements is discussed in turn below. Additional and/or different optical componentry suitable for use in optics assembly 140 will depend on a given target application or end-use and will be apparent in light of this disclosure. In accordance with some embodiments, optics assembly 140 may be compatible for use with a device 200 which emits a continuous wave (CW) output.

As noted above, optics assembly 140 optionally may include a beamsplitter 142. In the context of assembly 300, beamsplitter 142 may be disposed optically downstream of device 200 and configured to receive the output of device 200 and combine it with the output of aiming device 170 (discussed below), if present. To such ends, beamsplitter 142 may be (or otherwise may include) a dichroic mirror, in accordance with some embodiments.

As further noted above, optics assembly 140 may include a first optic (or optics group) 144. In the context of assembly 300, first optic(s) 144 may be disposed optically downstream of both device 200 and beamsplitter 142 and configured to receive the combined outputs of device 200 and aiming device 170 (discussed below). To such ends, first optic(s) 144 may be (or otherwise may include) a negative lens (e.g., diverging lens), in accordance with some embodiments. Also, as discussed below, first optic(s) 144 may be operatively coupled with an actuator 150 which permits first optic(s) 144 to be translationally movable for a customizable distance ‘x’ along the optical axis of optics assembly 140. In this manner, the movable first optic(s) 144 may be capable of focusing at least a portion of the output beam of assembly 300 at a sample plane that falls on a targeted sample at an extended standoff distance (e.g., about 1–5 m away).

As further noted above, optics assembly 140 may include a second optic (or optics group) 146. In the context of assembly 300, second optic(s) 146 may be disposed optically downstream of device 200, beamsplitter 142, and first optic(s) 144 and configured to receive the combined outputs of device 200 and aiming device 170 (discussed below) as transmitted through first optic(s) 144. To such ends, second optic(s) 146 may be (or otherwise may include), for example, (1) a first focusing lens 146a (e.g., plano-convex lens), (2) a second focusing lens 146b (e.g., double-convex lens), and (3) an optical window 146c, in accordance with some embodiments. Unlike with first optic(s) 144, second optic(s) 146 may be fixed in position along the optical axis of optics assembly 140.

As further noted above, accessory 100 also may include an actuator 150. Generally, actuator 150 may be operatively coupled with first optic(s) 144 and configured to move such optic(s) 144 in a substantially linear direction within a controlled distance range ‘x’ along the optical axis of optics assembly 140. As will be appreciated, movement of first optic(s) 144 by actuator 150 relative to (a) beamsplitter 142, if present, and/or (b) second optic(s) 146 may contribute, at least in part, to the ability of accessory 100 to increase the effective distance at which device 200 may scan a targeted sample accurately. As will be further appreciated, the range of movement—that is, the maximum distance ‘x’ of travel—afforded to first optic(s) 144 by actuator 150 may be customized, as desired for a given target application or end-use. To such ends, actuator 150 may be (or otherwise may include) any of a wide range of electric motor means, such as, for example, a servo motor, a stepper motor, and/or a piezoelectric motor, to name a few options. Actuator 150 may be powered, at least in part, by electronics assembly 160 (e.g., via a power supply 162 thereof), discussed below. In at least some cases, actuator 150 may be configured to move first optic(s) 144 based, at least in part, on data received from rangefinder device 180 and/or image capture device 182.

In accordance with some embodiments, in operation of assembly 300, (a) the focal length of the output of device 200 and (b) the focal length of optics assembly 140 may be selected such that spectral signature(s) of substance(s) located at the relevant sample plane (see FIG. 11) are detectable at remote distances, for example, of up to about 5 m away from optics assembly 140.

As further noted above, accessory 100 also may include an electronics assembly 160. Generally, electronics assembly 160 may be configured to energize and control any or all of the various electronic and electromechanical components of accessory 100. In some cases, electronics assembly 160 may be configured to receive and/or transmit one or more signals including data pertaining to a targeted sample scanned by device 200. To such ends, electronics assembly 160 may include any of a wide range of suitable electronic components, which may be populated on one or more appropriate substrates, such as a printed circuit board (PCB) or the like. For example, in accordance with some embodiments, electronics assembly 160 may include any one or more of the following: a controller configured to control actuator 150 in movement of first optic(s) 144; an encoder for rangefinder device 180, image capture device 182; a software interface; and a communication module (e.g., for wired and/or wireless communication, such as via a Wi-Fi or other suitable communication protocol).

In some embodiments, electronics assembly 160 may include a power supply 162. The power supply 162 may be configured to supply a given target amount of power to any of the various components of electronics assembly 160 and/or device 200 (when present in assembly 300). The power supply 162 may be (or may be compatible with) an alternating current (AC) power supply and/or a direct current (DC) power supply. In some cases, the power supply 162 may be (or otherwise may include) a battery, which may be permanent or replaceable and of a given cell size or capacity and type (e.g., alkaline, lithium ion, etc.). As noted above, the power supply 162 may serve, at least in part, to provide power to actuator 150 for operation thereof in moving first optic(s) 144. As can be seen from FIGS. 1–9, accessory 100 may include a button 164 (e.g., a physical and/or virtual button) actuatable to turn on/off accessory 100 and/or device 200. As further can be seen from FIGS. 1–9, accessory 100 optionally may include a power supply access 166 which provides for convenient access to the power supply 162 (e.g., for quick and repeatable replacement thereof).

In some embodiments, electronics assembly 160 may include one or more input/output (I/O) ports 168. A given I/O port 168 may be configured to receive and/or transmit signal(s) including data pertaining to (a) a targeted sample scanned by device 200 and/or (b) operation of accessory 100 and/or device 200 generally. In some cases, a given I/O port 168 may be, for example, an Ethernet port or a Universal Serial Bus (USB) port (e.g., a USB-C port). In some instances, a given I/O port 168 (e.g., USB-C port) may be configured to communicatively couple device 200 with accessory 100, for example, so that device 200 knows when to scan and when to transmit scan data to accessory 100. In some instances, a given I/O port 168 (e.g., Ethernet port) may be configured for data transmission and/or reception therethrough, allowing for control of accessory 100 and transmission of scan data out of accessory 100, for example, to a computing device (mobile or otherwise), a command module, or a given platform hosting accessory 100, as variously described herein.

As can be seen further from FIGS. 1–11, accessory 100 also may include a device interface portion 190. Generally, device interface portion 190 may be configured, at least in part, to facilitate operative interfacing of device 200 with accessory 100 in forming assembly 300. More specifically, device interface portion 190 may be configured, in accordance with some embodiments, to provide (a) optical coupling between device 200 and optics assembly 140 and, at least in some instances, (b) electrical coupling between device 200 and electronics assembly 160. In this manner, device interface portion 190 may provide for direct and/or indirect optical communication between (a) upstream device 200 and (b) downstream optics assembly 140 when such device 200 is hosted by accessory 100. Utilizing device interface portion 190, the output of device 200 may be delivered to optics assembly 140 for use in generating the overall output of accessory 100.

In accordance with some embodiments, device interface portion 190 also optionally may be configured with one or more light output safety features that prevent light output by device 200 and/or accessory 100 without first establishing certain required connection(s) (e.g., electrical, optical, and/or magnetic) therebetween. For example, in some embodiments, provision of light output safety via device interface portion 190 may involve establishing certain electrical connection(s) between device 200 and accessory 100 via a number of pins and contacts. In other embodiments, provision of light output safety via device interface portion 190 may involve a contactless approach, employing (a) infrared (IR) light emission and detection or (b) Hall effect (e.g., magnetic) detection between device 200 and accessory 100. In still other embodiments, a combination of contact-based and contactless approaches may be utilized via device interface portion 190 to effectuate a given level of light output safety. In accordance with some embodiments, device interface portion 190 may be configured to utilize any one (or combination) of the various light output safety features disclosed, for example, by PCT Application No. PCT/US2025/020685, entitled “Safety Systems and Techniques for Optical Instruments that Emit Light,” the disclosure of which is herein incorporated by reference in its entirety.

In accordance with some embodiments, accessory 100 optionally may include an aiming device 170. When included, aiming device 170 may be housed, in part or in whole, by second body portion 120. Aiming device 170 may be configured, at least in part, to emit light (e.g., visible light) which facilitates the aiming of assembly 300 in a given direction by a user. In some embodiments, aiming device 170 may be (or otherwise may include) an optical output device (e.g., a laser diode or other semiconductor light source/engine) configured to emit light having wavelength(s) in the range of about 380–700 nm. In an example case, aiming device 170 may be a green laser diode configured to emit light having a wavelength in the range of about 495–570 nm. In another example case, aiming device 170 may be a red laser diode configured to emit light having a wavelength in the range of about 620–700 nm. As noted above, in operation of assembly 300, the output of aiming device 170 may be combined with the output of device 200 by optics assembly 140 (e.g., via beamsplitter 142 thereof). Aiming device 170 may be coaxial (e.g., boresighted) with the optical axis of optics assembly 140 so as to allow a user to align assembly 300 quickly and accurately with a given targeted sample.

In accordance with some embodiments, accessory 100 optionally may include a rangefinder device 180. When included, rangefinder device 180 may be housed, in part or in whole, by second body portion 120. Rangefinder device 180 may be (or otherwise may include) a laser rangefinder device (e.g., a laser diode or other semiconductor light source/engine-based rangefinder) or a radar rangefinder device. In some cases, rangefinder device 180 may be configured for time-of-flight (TOF) or light detection and ranging (LIDAR)-based range-finding. In operation of assembly 300, rangefinder device 180 may be used, for example, to determine the distance between assembly 300 and a given targeted sample, and such ranging data then may be processed and/or presented to a user as desired. Storage of any ranging data captured using rangefinder device 180 may be performed locally (e.g., in memory of rangefinder device 180 itself and/or otherwise in electronics assembly 160) and/or remotely (e.g., in memory of device 200 and/or otherwise external to rangefinder device 180).

In accordance with some embodiments, accessory 100 optionally may include an image capture device 182. When included, image capture device 182 may be housed, in part or in whole, by second body portion 120. Image capture device 182 may be (or otherwise may include) a camera and/or a video camera including one or more image sensors and associated optic(s) configured to capture image(s) within its field of view (FOV), which may be fixed or adjustable, as desired. In operation of assembly 300, image capture device 182 may be used, for example, to capture image(s) of a given targeted sample and its surrounding environment, and such image data then may be processed and/or presented to a user as desired. Storage of any image(s) captured by image capture device 182 may be performed locally (e.g., in memory of image capture device 182 itself and/or otherwise in electronics assembly 160) and/or remotely (e.g., in memory of device 200 and/or otherwise external to image capture device 182). In accordance with some embodiments, image capture device 182 may be configured to provide for (a) viewing of a targeted sample, (b) alignment of assembly 300 to the targeted sample, and (c) video recording.

As can be seen further from FIGS. 1–9, accessory 100 also may include a mounting portion 130. Generally, mounting portion 130 may be configured, at least in part, to facilitate mounting of accessory 100 to a given platform in a temporary or permanent manner. In some embodiments, mounting portion 130 may be of a configuration compatible for use with one or more rail integration systems, including, for example, a Picatinny rail, a NATO accessory rail, a Weaver rail, and/or a dovetail rail, to name a few options. In some embodiments, mounting portion 130 may be of a configuration which complies, for example, with Modular Lock (MLOK) and/or KeyMod standards.

As will be appreciated in light of this disclosure, depending on its particular configuration, mounting portion 130 may permit accessory 100 to be mountable to any of a wide range of host platforms in any of a wide range of applications and contexts. For example, in some cases, accessory 100 may be mountable to a mobile platform, such as a vehicle, watercraft, or aircraft. In some cases, accessory 100 may be mountable to a remote-controlled vehicle, such as a radio-controlled (or other remotely controlled) car, boat, or plane, or an unmanned ground vehicle (UGV) or unmanned aerial vehicle (UAV), such as a drone, of civilian or military nature. In some cases, accessory 100 may be mountable to a static/fixed structure, such as a building or bunker. In some cases, accessory 100 may be mountable to a firearm. In some cases, accessory 100 may be mountable to a frame or stand, such as a tripod, bipod, monopod, or the like. Other suitable platform(s) for accessory 100 (and assembly 300 more generally) will depend on a given target application or end-use and will be apparent in light of this disclosure.

As will be appreciated in light of this disclosure, accessory 100 may be constructed from any of a wide range of suitable materials. In some cases, accessory 100 may be constructed, in part or in whole, from any one or combination of metals or alloys, such as, for instance, aluminum (Al), titanium (Ti), brass, or steel (e.g., stainless steel, carbon steel, or other steel), among others. In some cases, accessory 100 may be constructed, in part or in whole, from a rubber, plastic, or other polymer or resin, which optionally may be reinforced with any one, or combination, of carbon fibers, glass fibers, aramids, or any of the aforementioned metals or alloys. Other suitable construction materials for accessory 100 will depend on a given application and will be apparent in light of this disclosure.

Upon operative interfacing of device 200 and accessory 100 to form assembly 300, their respective optical pathways may be made to substantially align. As can be seen from FIG. 11, in operation of assembly 300, an excitation laser (e.g., a semiconductor laser diode) native to device 200 may emit an output having wavelength(s) in the near-infrared (NIR) spectrum, such as in the range of about 1,000–1,500 nm (e.g., at a wavelength of 1,064 nm). That output then may be transmitted out of device 200 and through device interface portion 190 to optics assembly 140 of accessory 100. In some cases, the output of device 200 optionally then may be combined with the output of aiming device 170 via beamsplitter 142, though this is not required. In any case, the output of device 200 may be passed through first optic(s) 144 and second optic(s) 146 and subsequently directed out of accessory 100 for impingement on a targeted sample (e.g., on a given surface or within an optically translucent/transparent container) at a given distance away from assembly 300. Signal(s) resulting from such scanning of the sample then may be reflected to accessory 100, passing back through second optic(s) 146, first optic(s) 144, and (if optionally present) beamsplitter 142 before being transmitted through device interface portion 190 to device 200. Within device 200, such incoming signal(s) may pass through spectrometer optic(s) native to device 200 before impinging on a grating of device 200 and being directed to a detector (e.g., a NIR-sensitive sensor) of device 200. Data in these signal(s) received by device 200 may undergo processing, locally or otherwise, to determine substance(s) present in the sample, as identified by comparison against known spectral signature(s).

As will be appreciated in light of this disclosure, device 200 may have any of a wide range of configurations suitable for use with accessory 100. For example, the detector of device 200 may be (or otherwise may include) any one or more of the following: an indium-gallium-arsenide (InGaAs) sensor; a charge-coupled device (CCD)-style sensor; an intensified CCD (ICCD)-style sensor; and a complimentary metal–oxide–semiconductor (CMOS)-style sensor. Also, as will be appreciated, when utilized with accessory 100, the detector of device 200 may not be required to operate in a time domain-limited or frequency domain-limited manner in operation of assembly 300. As will be further appreciated, when utilized with accessory 100, the excitation laser of device 200 may not be required to operate in a time domain-restricted or frequency domain-restricted manner in operation of assembly 300. Additionally, as will be appreciated, when utilized with accessory 100, device 200 may include a user interface (UI) configured for selecting target(s) and initiating data collection in operation of assembly 300.

### Example Implementation Data

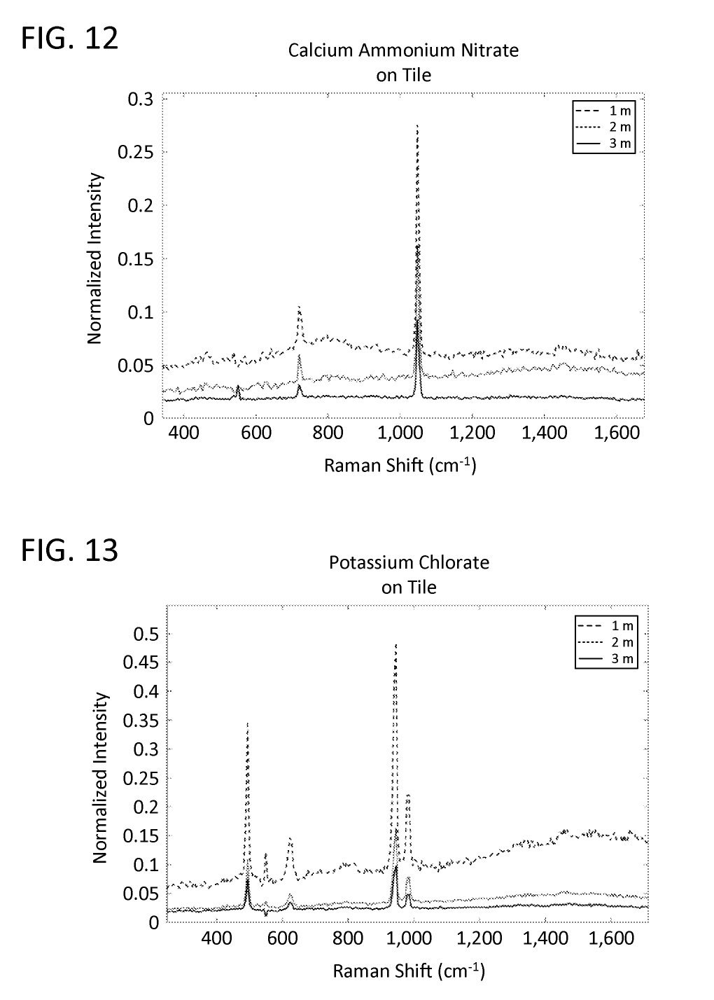

FIG. 12 is a plot of several Raman spectra relating to a Calcium Ammonium Nitrate sample disposed on tile, as detected at distances of 1 m, 2 m, and 3 m utilizing a standoff accessory 100 configured in accordance with an embodiment of the present disclosure.

FIG. 13 is a plot of several Raman spectra relating to a Potassium Chlorate sample disposed on tile, as detected at distances of 1 m, 2 m, and 3 m utilizing a standoff accessory 100 configured in accordance with an embodiment of the present disclosure.

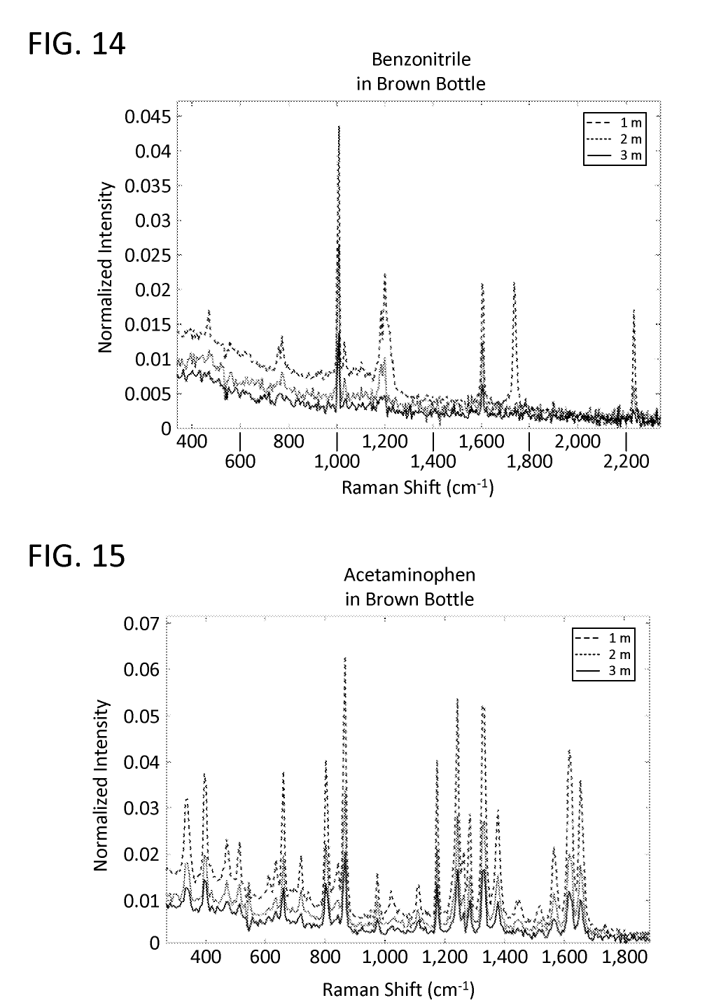

FIG. 14 is a plot of several Raman spectra relating to a Benzonitrile sample disposed within a brown bottle, as detected at distances of 1 m, 2 m, and 3 m utilizing a standoff accessory 100 configured in accordance with an embodiment of the present disclosure.

FIG. 15 is a plot of several Raman spectra relating to an Acetaminophen sample disposed within a brown bottle, as detected at distances of 1 m, 2 m, and 3 m utilizing a standoff accessory 100 configured in accordance with an embodiment of the present disclosure.

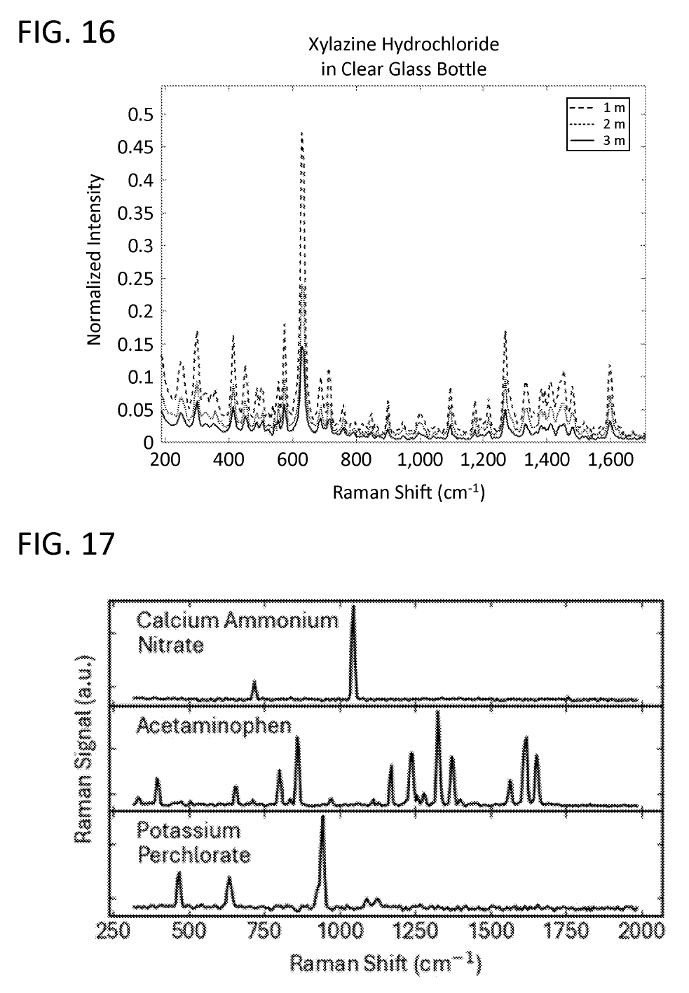

FIG. 16 is a plot of several Raman spectra relating to a Xylazine Hydrochloride sample disposed within a clear glass bottle, as detected at distances of 1 m, 2 m, and 3 m utilizing a standoff accessory 100 configured in accordance with an embodiment of the present disclosure.

FIG. 17 is a plot of several Raman spectra relating to (a) a Calcium Ammonium Nitrate sample disposed on tile, (b) an Acetaminophen sample disposed within a clear, low-density polyethylene (LDPE) bag, and (c) a Potassium Perchlorate sample disposed on tile, as detected at distances ranging between 1.5–2.0 m in an indoor environment utilizing a standoff accessory 100 configured in accordance with an embodiment of the present disclosure.

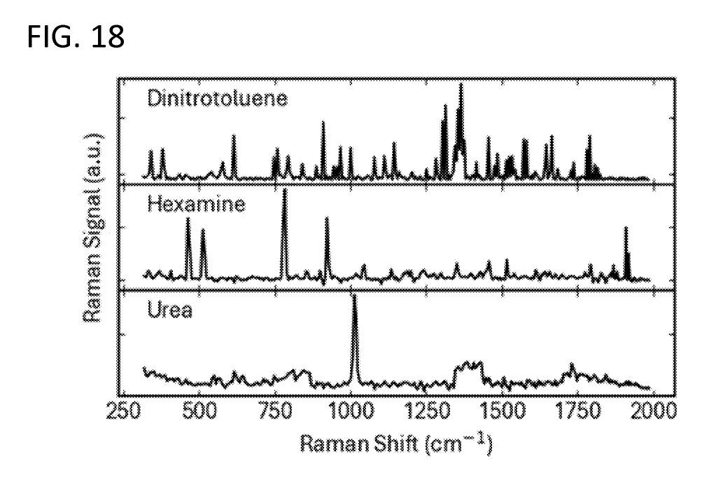

FIG. 18 is a plot of several Raman spectra relating to (a) a Dinitrotoluene sample disposed within a clear, glass vial, (b) a Hexamine sample in tablet form disposed within an LDPE bag, and (c) a Urea sample in pill form disposed within an LDPE bag, as detected at distances ranging between 1.5–2.0 m in an outdoor, sunny environment utilizing a standoff accessory 100 configured in accordance with an embodiment of the present disclosure.

In considering the data plotted in FIGS. 12–18, the Raman spectral data presented are notable for being readily recognizable to a person skilled in the art. By contrast, existing technologies typically require substantial post-acquisition processing or manipulation of Raman spectral data, resulting in output that is not generally discernible by a skilled practitioner as a specific chemical or set of chemicals.

As will be appreciated, the spectra collected in FIGS. 12–16, for example, exhibit greater intensity at the shortest measurement distance (e.g., 1 m) and progressively reduced intensity at greater distances (e.g., 2 m and 3 m, respectively) when acquired using a standoff accessory 100 configured in accordance with some embodiments of the present disclosure. Notwithstanding these changes in overall signal intensity, the characteristic spectral features for each material remain substantially unchanged even at the farthest (e.g., 3 m) distance. Such stability may permit an appropriately configured data-recognition software module, for example, to identify a chemical match for each material, in accordance with some embodiments.

As will be further appreciated, FIGS. 12–13 illustrate spectra for materials commonly associated with homemade explosives (HME), FIG. 14 illustrates spectra for a representative industrial material, and FIGS. 15–16 illustrate spectra for two pharmaceutical materials commonly encountered as cutting agents in narcotics-interdiction applications. These materials represent preferred targets for standoff identification to support operator hazard-mitigation efforts. In some configurations of standoff accessory 100, similar spectra may be reproducible at different distance increments, including but not limited to 3 m, 4 m, and 5 m, depending, at least in part, on the specific configuration of optics assembly 140 present.

As will be further appreciated, FIGS. 17–18 illustrate the capability of assembly 300, in accordance with some embodiments, to reduce environmental light noise both indoors (FIG. 17) and outdoors (FIG. 18) for a range of materials, including simple materials such as calcium ammonium nitrate and urea, as well as more complex materials such as acetaminophen and dinitrotoluene. Except for acetaminophen, the materials shown in FIGS. 17–18 are recognized explosive precursors and may present hazards to operators in point-and-shoot configurations if not handled appropriately. FIG. 18 further demonstrates that, in accordance with some embodiments, assembly 300 can discriminate Raman signals from solar-background interference—an ability that existing approaches employing similar excitation wavelengths frequently struggle to achieve without resorting to elaborate laser-modulation techniques or post-acquisition manipulation that renders data unrecognizable by a skilled practitioner.

### Further Examples

The following examples pertain to some further embodiments of the disclosure, from which numerous permutations and combinations will be apparent.

Example 1 is a standoff accessory configured to operatively interface with a handheld or otherwise portable Raman spectroscopy device, the standoff accessory including: a first body portion configured to physically host the Raman spectroscopy device; a second body portion including: an optics assembly including a first optic; and an actuator configured to move the first optic along an optical axis of the optics assembly; and an interface portion configured to optically couple the Raman spectroscopy device with the optics assembly such that movement of the first optic along the optical axis augments a Raman scanning capability native to the Raman spectroscopy device, allowing for scanning of a targeted sample by the Raman spectroscopy device at a standoff distance of about 1–5 m away from the targeted sample.

Example 2 includes the subject matter of any of Examples 1 and 3–33, wherein the optics assembly is configured as a scope.

Example 3 includes the subject matter of any of Examples 1–2 and 4–33, wherein the first optic includes a negative lens.

Example 4 includes the subject matter of any of Examples 1–3 and 5–33, wherein the optics assembly further includes a second optic which is fixed in position along the optical axis of the optical assembly.

Example 5 includes the subject matter of any of Examples 1–4 and 6–33, wherein the second optic includes at least one focusing lens.

Example 6 includes the subject matter of any of Examples 1–5 and 7–33, wherein the at least one focusing lens includes: a first focusing lens which is configured as a plano-convex lens; and a second focusing lens which is configured as a double-convex lens.

Example 7 includes the subject matter of any of Examples 1–6 and 8–33, wherein the second optic further includes an optical window.

Example 8 includes the subject matter of any of Examples 1–7 and 9–33, the standoff accessory further including an electronics assembly configured to cause the actuator to move the first optic along the optical axis of the optics assembly.

Example 9 includes the subject matter of any of Examples 1–8 and 10–33, wherein the electronics assembly further includes a power supply electrically coupled with the actuator.

Example 10 includes the subject matter of any of Examples 1–9 and 11–33, wherein the power supply includes a battery.

Example 11 includes the subject matter of any of Examples 1–10 and 12–33, the standoff accessory further including an aiming device configured to emit visible light.

Example 12 includes the subject matter of any of Examples 1–11 and 13–33, wherein the visible light includes a wavelength in the range of about 380–700 nm.

Example 13 includes the subject matter of any of Examples 1–12 and 14–33, wherein the visible light includes a wavelength in the range of about 495–570 nm.

Example 14 includes the subject matter of any of Examples 1–13 and 15–33, wherein the aiming device is boresighted with the optical axis of the optical assembly.

Example 15 includes the subject matter of any of Examples 1–14 and 16–33, wherein the optics assembly further includes a beamsplitter configured to combine the visible light emitted by the aiming device with an output of the Raman spectroscopy device.

Example 16 includes the subject matter of any of Examples 1–15 and 17–33, wherein the beamsplitter includes a dichroic mirror.

Example 17 includes the subject matter of any of Examples 1–16 and 18–33, wherein the first optic is movable relative to the beamsplitter.

Example 18 includes the subject matter of any of Examples 1–17 and 19–33, the standoff accessory further including a rangefinder device configured to determine the standoff distance.

Example 19 includes the subject matter of any of Examples 1–18 and 20–33, wherein the rangefinder device is configured for time-of-flight (TOF) or light detection and ranging (LIDAR)-based range-finding.

Example 20 includes the subject matter of any of Examples 1–19 and 21–33, wherein the actuator is configured to move the first optic along the optical axis of the optics assembly based, at least in part, on data received from the rangefinder device.

Example 21 includes the subject matter of any of Examples 1–20 and 22–33, the standoff accessory further including an image capture device configured to capture at least one of a still image and a video of the targeted sample.

Example 22 includes the subject matter of any of Examples 1–21 and 23–33, the standoff accessory further including a mounting portion configured for mounting the standoff accessory to a platform.

Example 23 includes the subject matter of any of Examples 1–22 and 24–33, wherein the platform is a mobile platform.

Example 24 includes the subject matter of any of Examples 1–23 and 25–33, wherein the platform is a firearm.

Example 25 includes the subject matter of any of Examples 1–24 and 26–33, wherein the platform is an unmanned ground vehicle (UGV) or an unmanned aerial vehicle (UAV).

Example 26 includes the subject matter of any of Examples 1–25 and 27–33, wherein the platform is a stationary, fixed platform.

Example 27 is an assembly including: the standoff accessory including the subject matter of any of Examples 1–26; and the Raman spectroscopy device.

Example 28 includes the subject matter of any of Examples 27 and 29–33, wherein the Raman spectroscopy device includes an excitation laser configured to emit near-infrared (NIR) light.

Example 29 includes the subject matter of any of Examples 27–28 and 30–33, wherein the NIR light includes a wavelength in the range of about 1,000–1,500 nm.

Example 30 includes the subject matter of any of Examples 27–29 and 31–33, wherein the NIR light includes a wavelength of 1,064 nm.

Example 31 includes the subject matter of any of Examples 27–30 and 32–33, wherein the Raman spectroscopy device is a semiconductor-based Raman spectroscopy device configured to operate at a wavelength of 1,064 nm.

Example 32 includes the subject matter of any of Examples 27–31 and 33, wherein the Raman spectroscopy device includes a detector that is sensitive to near-infrared (NIR) light.

Example 33 includes the subject matter of any of Examples 27–32, wherein the detector includes at least one of: an indium-gallium-arsenide (InGaAs) sensor; a charge-coupled device (CCD)-style sensor; an intensified CCD (ICCD)-style sensor; and a complimentary metal–oxide–semiconductor (CMOS)-style sensor.

The foregoing description of example embodiments has been presented for the purposes of illustration and description. It is not intended to be exhaustive or to limit the present disclosure to the precise forms disclosed. Many modifications and variations are possible in light of this disclosure. It is intended that the scope of the present disclosure not be limited by this detailed description. Future-filed applications claiming priority to this application may claim the disclosed subject matter in a different manner and generally may include any set of one or more limitations as variously disclosed or otherwise demonstrated herein.

What is claimed is:

1. A standoff accessory configured to operatively interface with a handheld or otherwise portable Raman spectroscopy device, the standoff accessory comprising:
a first body portion configured to physically host the Raman spectroscopy device;
a second body portion comprising:
an optics assembly comprising a first optic; and
an actuator configured to move the first optic along an optical axis of the optics assembly; and
an interface portion configured to optically couple the Raman spectroscopy device with the optics assembly such that movement of the first optic along the optical axis augments a Raman scanning capability native to the Raman spectroscopy device, allowing for scanning of a targeted sample by the Raman spectroscopy device at a standoff distance of about 1–5 m away from the targeted sample.

2. The standoff accessory of claim 1, wherein the optics assembly is configured as a scope.

3. The standoff accessory of claim 1, wherein the first optic comprises a negative lens.

4. The standoff accessory of claim 1, wherein the optics assembly further comprises a second optic which is fixed in position along the optical axis of the optical assembly.

5. The standoff accessory of claim 4, wherein the second optic comprises at least one focusing lens.

6. The standoff accessory of claim 5, wherein the at least one focusing lens comprises:
a first focusing lens which is configured as a plano-convex lens; and
a second focusing lens which is configured as a double-convex lens.

7. The standoff accessory of claim 5, wherein the second optic further comprises an optical window.

8. The standoff accessory of claim 1, further comprising an electronics assembly configured to cause the actuator to move the first optic along the optical axis of the optics assembly.

9. The standoff accessory of claim 1, further comprising an aiming device configured to emit visible light, wherein the visible light comprises a wavelength in the range of about 380–700 nm.

10. The standoff accessory of claim 1, further comprising an aiming device configured to emit visible light, wherein the visible light comprises a wavelength in the range of about 495–570 nm.

11. The standoff accessory of claim 1, further comprising an aiming device configured to emit visible light, wherein the optics assembly further comprises a beamsplitter configured to combine the visible light emitted by the aiming device with an output of the Raman spectroscopy device.

12. The standoff accessory of claim 11, wherein the first optic is movable relative to the beamsplitter.

13. The standoff accessory of claim 1, further comprising a rangefinder device configured to determine the standoff distance.

14. The standoff accessory of claim 13, wherein the actuator is configured to move the first optic along the optical axis of the optics assembly based, at least in part, on data received from the rangefinder device.

15. The standoff accessory of claim 1, further comprising an image capture device configured to capture at least one of a still image and a video of the targeted sample.

16. The standoff accessory of claim 1, further comprising a mounting portion configured for mounting the standoff accessory to a platform, wherein the platform is a firearm.

17. The standoff accessory of claim 1, further comprising a mounting portion configured for mounting the standoff accessory to a platform, wherein the platform is an unmanned ground vehicle (UGV) or an unmanned aerial vehicle (UAV).

18. An assembly comprising:
the standoff accessory of claim 1; and
the Raman spectroscopy device.

19. The assembly of claim 18, wherein the Raman spectroscopy device comprises an excitation laser configured to emit near-infrared (NIR) light comprising a wavelength in the range of about 1,000–1,500 nm.

20. The assembly of claim 18, wherein the Raman spectroscopy device is a semiconductor-based Raman spectroscopy device configured to operate at a wavelength of 1,064 nm.
